(19) United States
(12) Patent Application Publication
(10) Pub. No.: US 2022/0266609 A1
(43) Pub. Date: Aug. 25, 2022

(54) Apparatus and Method for Printing Profiled Bodies, Especially Edge Bands

(71) Applicant: FRITZ EGGER GmbH & Co. OG, St. Johann in Tirol (AT)

(72) Inventor: Klaus Fischer, Bad Berleburg (DE)

(21) Appl. No.: 17/625,515

(22) PCT Filed: Jun. 25, 2020
(86) PCT No.: PCT/EP2020/067897

§ 371 Date: Jan. 7, 2022

(30) Foreign Application Priority Data
Jul. 10, 2019 (EP) 19185420.7

(51) Int. Cl. B41J 11/00; B41J 25/00; B41J 3/407; B41M 5/00; B41M 7/00

(52) U.S. Cl. CPC B41J 11/00214; B41J 25/006; B41J 3/407; B41J 11/0022; B41M 5/0088; B41M 5/0011; B41M 7/0081; A47B 96/201

(57) ABSTRACT

The invention relates to a device for printing on edge bands including at least one printhead for producing a printed image on the edge band; a linear drive for moving the at least one printhead in a printing direction within a printing region between two end positions; a feeding apparatus for feeding the edge band into the printing region in a transport direction; and a control apparatus for controlling the at least one printhead, the linear drive and the feeding apparatus. The technical problem of technically and economically improving the process of printing on edge bands is solved in that the transport direction of the edge band is oriented substantially parallel to the printing direction. The invention further relates to a method for printing on edge bands.

### CROSS-REFERENCE TO RELATED APPLICATIONS

This application is the United States national phase of International Application No. PCT/EP2020/067897 filed Jun. 25, 2020, and claims priority to European Patent Application No. 19185420.7 filed Jul. 10, 2019, the disclosures of which are hereby incorporated by reference in their entirety.

### BACKGROUND OF THE INVENTION

### Field of the Invention

The invention relates to a device for printing edge strips, having at least one print head for producing a printed image on the profiled body, having a linear drive for moving the at least one print head in a printing direction within a printing area between two end positions, having a feeding device for feeding a profiled body into the printing area along a transport direction, and having a control device for controlling the at least one print head, the linear drive and the feeding device. The invention also relates to a corresponding method for printing edge bands.

### Description of Related Art

Edge bands, or profiled bodies in general, are increasingly being used in the industrial production of furniture or kitchen panels. As machine processing can be carried out with increasing precision, higher demands are also being placed on the edge bands themselves, not only in terms of processing properties, but also in terms of optical properties.

DE 10 2015 118 055 A1 discloses a method for producing an edge band by coextrusion in such a way that, in addition to the base body, a decorative base is also already formed, which is provided with the final decoration by a further printing process. The printing device is integrated in the in-line manufacturing process and comprises a plurality of print heads, for example up to ten print heads, for different colors. Since the print heads are arranged stationary and the edge band to be printed is continuously moved under the print heads, the printing process is also performed continuously.

DE 10 2008 010 738 A1 describes a manufacturing method in which, in a first step, a decorative base is printed onto a pre-product manufactured by extrusion, and the decoration is then completed by means of digital printing.

Because the printing inks are applied one after the other in one pass of the edge band to be printed, this technique is also called single-pass printing.

JP 2009 292128 A describes a device with a printing unit and a blower unit for printing on paper, art paper, films or the like, wherein the printing medium is fixed on a printing plate by means of a vacuum during the printing process. Subsequently, the blower unit dries the applied ink.

US 2014/0340442 A1 shows a device for printing on paper provided as roll goods, comprising a conveying device, a supporting part, a suction device, a recording part, a heating part and a control, wherein the control is configured to control the suction device in such a way that the paper to be printed is held on the supporting part by means of suction force during printing by the recording part.

US2013/0258014 A1 discloses an apparatus for printing on paper- or film-based media, comprising a conveying unit which intermittently guides the medium to be printed along a transport path to a support unit on which the medium is held in position by means of a suction unit during printing which is performed by a recording unit.

These manufacturing methods can be carried out in single-pass plants for edge bands or generally for profiled bodies with widths of up to 700 mm, whereby either one edge band or a plurality of edge bands to be subsequently separated or generally profiled bodies are produced. However, various problems have been encountered in the application of this single-pass system.

For each of the colours to be applied, several stationary print heads are required across the width of the profiled body to be printed. Due to the stationary arrangement of the print heads, a spray mist is produced during printing, which can impair the print quality. A static charge of the edge band or the profiled bodies to be printed intensifies the effect, so that the resulting spray mist remains above the edge band. Therefore, additional measures such as generating an additional air flow are necessary. Also, additional suction devices become necessary directly after printing each individual color directly following the respective print head above the edge band to be printed. In addition, the spray mist may cause droplets to be deposited on surfaces of the printing device, which then fall onto the substrate to be printed and thus damage it.

Since the various inks are applied one after the other with a time lag due to the spatial distance between the individual print heads, it is necessary to fix the respective ink applications before printing with the next print head. For this purpose, LEDs, so-called pinnings (fixing light-emitting diodes), or UV light sources are provided between the print heads, the radiation of which at least partially hardens the respective freshly printed ink drops on the edge band after each ink application. Since the LEDs or the UV light sources are arranged close to the adjacent print heads, there are also interactions and thus impairments of the printing process. The so-called scattered radiation of the LED or UV light sources therefore negatively influence the usability of the directly positioned print heads in such a way that their nozzles become clogged due to unwanted curing of the ink. Elaborate radiation shields between the individual print heads and corresponding shields are therefore technically necessary.

For example, if edge bands are produced by means of a structured calender roll with a pore structure that is to coincide with the decor, i.e. a so-called synchronous pore, then very precise synchronization of the print image with the surface structure is required. Due to the edge band continuously passing under the print heads, high demands are placed on the synchronization process.

Another disadvantage is the stationary arrangement of the print heads, which are only accessible to a limited extent and therefore require considerable technical effort for maintenance and replacement. Finally, the cost of the printing system is also a disadvantage, since no standard industrial printers that work according to the multi-pass process can be used.

### SUMMARY OF THE INVENTION

Therefore, the present invention is based on the technical problem of improving technically and economically the printing of profiled bodies, in particular edge bands.

According to the invention, the aforementioned technical problem is solved by a Device for printing edge bands and thus for producing a decoration on the profiled body solved with at least one print head for producing a print image on the profiled body, with a linear drive for moving the at least one print head in a printing direction within a printing area between two end positions, with a feeding device for feeding a profiled body into the printing area along a transport direction, and with a control device for controlling the at least one print head, the linear drive and the feeding device, which is characterized in that the transport direction of the profiled body is oriented essentially parallel to the printing direction.

The aforementioned technical problem is also solved by a method for printing edge bands, in which a print image is produced on the profiled body using at least one print head, in which the at least one print head is moved within a printing area between two end positions in a printing direction, in which a profiled body is fed into the printing area along a transport direction, and in which the edge band is transported essentially parallel to the printing direction.

The invention relates in particular to the printing of edge bands, but is also generally applicable to profiled bodies. Profiled bodies are understood to be those used in furniture construction and in home furnishings and interior fittings. These can be end edges, especially in kitchens, skirting boards, transition strips or also slats of roller shutters or curtains. The profiled bodies or edge bands to be printed can be made of thermoplastic materials, preferably ABS, PVC, PP, PE, PET or similar plastics. In a special embodiment, materials made of paper and paper/plastic combinations are also possible.

When the invention is described below by way of example using edge bands, this is not understood to be limiting.

The expression “substantially parallel” means that in principle the transport direction and the printing direction coincide, but that small deviations from parallelism may occur during the movement of the at least one print head.

According to the invention, it was therefore recognized that the effectiveness of printing the edge band is improved by utilizing the entire stroke of a reciprocating motion of the at least print head of industrial multi-pass digital printers without each individual reciprocating motion of the at least print head being limited by the width of the edge band being fed. Thus, the entire stroke of the at least one print head is utilized for applying the digital print.

Since the total stroke of an industrial multi-pass digital printing device is in the range of up to 5200 mm, preferably 2600 mm, the at least one print head is moved over a sufficiently long distance so that spray mist generated cannot accumulate in the area of the moving print head.

Furthermore, the use of a described printing device with a movable print head for multi-pass printing has the advantage that the at least one print head is easily accessible in its rest position and maintenance of the print head is thus facilitated. Furthermore, there is a cost advantage in using an industrial printing device and not having to rely on a special construction.

In principle, it is possible to superimpose a movement of the edge band in the transport direction and a movement of the at least one print head in the printing direction and thus to optimize printing. However, it is preferred that the control device is arranged to feed and position the edge band into the printing area in cycle mode by means of the feeding device and that the control device is arranged to move the at least one print head by means of the linear drive and to control it for a printing process for printing the edge band. In particular, after the edge band has been positioned, the at least one print head is moved. Likewise, a linear movement of the at least one print head is possible simultaneously with the transport of the edge band.

The corresponding method can be carried out by feeding and positioning the edge band in the printing area in cycle mode and in which the at least one print head is moved and controlled for a printing operation for printing the edge band.

In this context, the term “being arranged” is to be understood as meaning that the control device comprises all the electronic microchips, memories and transducers necessary for controlling the at least one print head, the linear drive and the feeding device, in order to record measurement signals such as position signals and print parameters and to generate control signals. The control device may thus comprise a plurality of components arranged at the same or different locations of the device.

Furthermore, the term “positioning” means to precisely arrange the edge band relative to the device and to fix it, for example, for the period of the printing process.

Thus, the edge band is held at rest while the printing operation of multi-pass printing is performed. After the printing process is finished, the edge band is further guided by the feeding device by a predetermined distance and repositioned to continue seamless printing of the edge band.

In a preferred manner, it is provided that a suction table function for positioning the edge band is integrated at least in sections in the printing area. In this way, when the predefined position is reached, the edge band is fixed even better during the following printing process.

The use of the feeding device when positioning the edge band, i.e. fixing the edge band during the printing process, results in improved accuracy when printing a synchronous pore, i.e. a printed image synchronous with a surface structure already introduced into the edge band. This is because the guidance of the at least one print head relative to the stationary edge band can be adjusted much more precisely than is the case with a single-pass printing device with stationary print heads and running edge band, so that an improved synchronous correspondence with a surface structure is achieved.

In a further preferred manner, the described device is characterized in that at least on one side, preferably on both sides of the at least one print head in the printing direction, at least one curing source, preferably a radiation source, in particular an LED and/or UV light source, or preferably a hot air source is provided for curing the printing ink.

The process can thus preferably be supplemented by curing the printing ink during the printing process in the printing direction behind the imprint, in particular by means of LED or UV light.

If aqueous pigmented inks are used, the ink droplets can also be fixed by heating the edge band or profiled body. The edge band or profiled body to be printed then has an ink-absorbent surface geometry, e.g. a paper surface or a profiled surface pre-treated by means of plasma treatment. Heated guide areas or transport rollers, for example, are used to heat the substrate to be printed in order to specifically support the drying process and make it controllable.

The curing of the applied printing ink has the advantage that the printed image, which already consists of several, for example four, colors (CYMK), is fixed and cannot run or can only run to a small extent before the application of at least one further color, i.e. in a bidirectional multi-pass process. Moreover, due to the time interval between the curing and the printing of the at least one further color, there is no mutual interference between the radiation and the print head.

After the entire print image has hardened, it can still be sealed, for example by applying a varnish.

Furthermore, it is advantageous if a deionization means, in particular in the form of a deionization bar or a deionization blower, is arranged at least on one side of the at least one print head. In the corresponding method, the step is carried out in which the edge band is deionized in the printing direction before printing. Thus, at each stroke during the printing process, the edge band to be printed is deionized. The deionization bar or the deionization blower is arranged at a distance from the edge band without contact and applies ions to the surface in a known manner. Thus, the deionization takes place outside the printing area in the printing direction in front of the at least one print head.

The described printing device can be used in various arrangements. On the one hand, the device can be used in an inline manufacturing process downstream of an extrusion or coextrusion for producing the edge band, a calender arrangement for consolidating, pressing in surface structures and, if necessary, printing one or more colour layers for building up a decorative base. In this case, the continuous supply of band edge material must be temporarily stored by a buffer arrangement, for example by a dancer arrangement, in order to be able to implement a timed feed within the printing device.

The same arrangement can be used in a continuous unwinding process of a prefabricated strip edge material stored on a roll. Here, too, intermediate storage is necessary.

On the other hand, the printing device can be used in an arrangement with a cycled unwinding of strip edge material from a roll, in which case no intermediate storage between roll and printing device is necessary and the cycling of unwinding and insertion into the printing area can be synchronized.

With the previously described method or with the previously described device—as described—coloured printed images can be generated, which are printed onto already structured edge bands or profiled bodies. However, the described printing device can itself also be used to generate a surface structure. For this purpose, a 3D surface structure is generated, preferably in a plurality of strokes, using a monochromatic ink, in particular white ink, which is subsequently decorated in color in further strokes of the same printing device or of a further printing device. This form of structuring can therefore also be understood as 3D printing.

The process described above can be extended in that the edge band printed with a decoration or the corresponding profiled body is further refined, in particular directly in the same process, by at least one subsequent lacquering. The lacquering can also take place later, in particular after a roll-up.

### BRIEF DESCRIPTION OF THE DRAWINGS

In the following, the invention will be explained by means of embodiments with reference to the drawing. The drawing shows

FIG. 1 A schematic front view of a device according to the invention,

FIG. 2 a print head in an enlarged schematic side view and

FIG. 3 an arrangement of print heads in a schematic top view.

### DESCRIPTION OF THE INVENTION

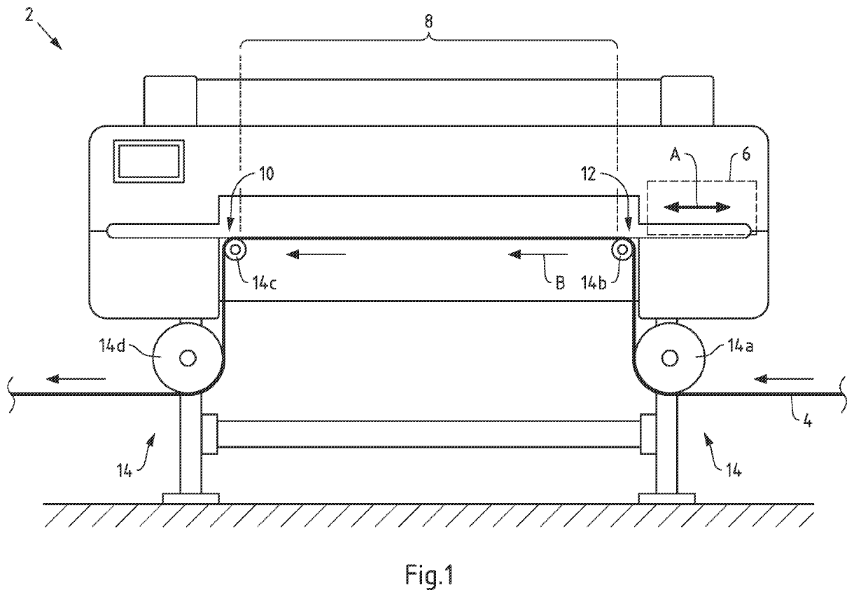

The device 2 according to the invention shown in FIG. 1 for printing on edge bands 4 firstly comprises a print head 6 for generating a print image on the edge band 4. The printing device 2 shown may comprise an industrial digital printing machine with an inkjet print head, which can be moved from right to left or left to right in the lateral view shown in FIG. 1.

The printhead 6 is suitable for a multi-pass printing process, whereby all four CYMK colors of a color system are applied simultaneously. For the four CYMK inks at least one stroke, i.e. a complete back and forth movement of the printhead unit, is necessary.

To increase the print image resolution, it is also possible to generate the print image specifically by at least one complete back and forth movement of the printhead unit, i.e. by two strokes. This type of print image generation is referred to in the technology as “bidirectional print mode”.

Optionally, it is possible to add further colors, e.g. light colors, to the usually used number of the four inks CMYK mentioned here, i.e. Cyan, Magenta, Yellow, Black. Also conceivable are green, blue, red or orange or mixed colors such as beige, light brown, medium gray. The invention described is therefore not limited to the use of the four colors CMYK. Many other colors are optionally applicable. Thus, the representable color space can be adapted to the requirements of the color design. For the application of further colors, the print head units of the printer can be extended by further print heads, or separate print head units are used.

The printing device has a linear drive for moving the print head 6 in a printing direction A within a printing area 8 between two end positions 10 and 12. The linear drive allows a very precise movement of the print head 6 and enables a detailed print image to be produced which may be synchronised with a surface structure.

Furthermore, a feeding device 14 for feeding the edge band 4 into the printing area 8 along a transport direction B is provided, wherein in the present example four transport rollers 14a to 14d are provided, which are driven at least partially by means of a drive unit not shown. Furthermore, a control device, also not shown, is provided for controlling the print head 4, the linear drive and the feeding device 14.

According to the invention, the device is designed in such a way that the transport direction B of the edge band is aligned essentially parallel to the printing direction A. In FIG. 1, the two directions are shown with parallel arrows, where substantially parallel means that a small deviation from parallelism may occur in individual movements, but that in principle the transport direction and the printing direction coincide.

Further, the control device is arranged to feed and position the edge band 4 into the printing area 8 in cycle mode by means of the feeding device 14, and the control device is arranged to move the print head 6 by means of the linear drive and to control it for a printing operation for printing the edge band 4 when the edge band 4 is positioned in the printing area.

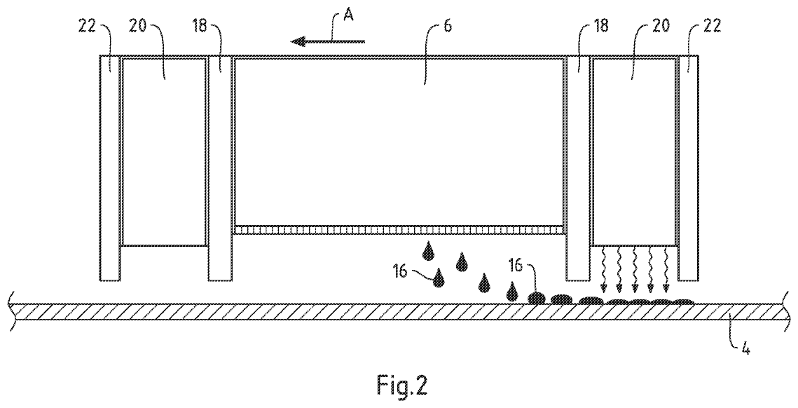

FIG. 2 shows a print head 6 in a schematic side view in an arrangement above the edge band 4. The arrow A shows the printing direction from right to left. The relative movement between the print head 6 and the edge band 4 can also be seen by the spatial distribution of the ink drops 16.

Apertures 18 and radiation sources 20 are arranged on both sides of the print head 6, which in this example are designed as UV light sources and cure the ink drops 16 applied to the edge band 4 with their radiation. The apertures 18 thereby shield the area below the print head 6, so that the ink drops 16 are not cured until after they have been applied to the edge band 4.

Furthermore, deionization rods 22 are arranged on both sides of the radiation sources 20, at the ends of which directed towards the edge band 4 ions or ion clusters emerge and lead to a deionization of the edge band 4. Since the deionization takes place before printing by the print head 6, the left deionization rod 22 is active in printing direction A (FIG. 2), while the right radiation source 20 is active after the printing process.

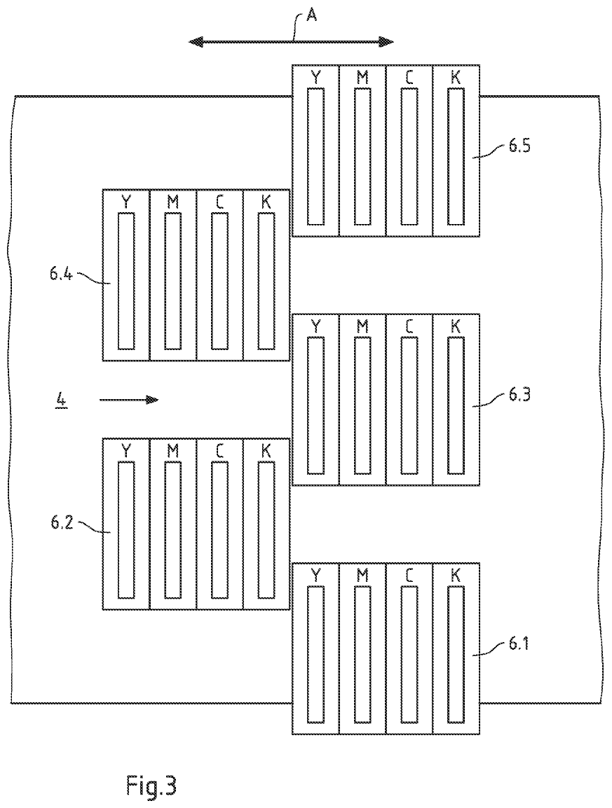

FIG. 3 further shows a top view of an arrangement of a plurality of print heads 6.1 to 6.5, which are arranged offset from each other and overlapping in two rows in the printing direction A. Within each of the print heads 6.1 to 6.5 lines are drawn which are marked from left to right with the letters Y, M, C and K for the four basic colours of CYMK printing cyan, yellow, magenta and black (key). When the print heads 6.1 to 6.5 are moved along the edge band 4, a closed print image can thus be produced.

1. A device for printing on edging strips, comprising:
at least one print head for producing a print image on the profiled body,
a linear drive for moving the at least one print head in a print direction within a print area between two end positions,
a feeding device for feeding the profiled body into the pressure area along a transport direction and
a control device for controlling the at least one print head, the linear drive and the feeding device,
wherein the transport direction of the profiled body is oriented essentially parallel to the pressure direction.

2. The device according to claim 1,
wherein the control device is set up to feed and position the profiled body into the pressure area by means of the feeding device in cycle mode, and
that the control device is set up to move the at least one print head by means of the linear drive and to control it for a printing process for printing the profiled body.

3. The device according to claim 1,
wherein a suction table function for positioning the profiled body is integrated at least in sections in the pressure region.

4. The device according to claim 1,
wherein at least one curing source, preferably a radiation source, in particular an LED and/or UV light source, or preferably a hot air source for curing the printing ink, is provided at least on one side, preferably on both sides, of the at least one printing head 4) in the printing direction.

5. The device according to claim 1,
wherein a deionization means, in particular in the form of a deionization bar or a deionization blower, is arranged at least on one side of the at least one print head.

6. A method for printing on edge bands,
in which a print image is produced on the profiled body with at least one print head,
in which the at least one print head is moved between two end positions during the printing process in a printing direction within a printing range,
in which the profiled body is fed into the printing area along a transport direction which is essentially parallel to the printing direction.

7. The method according to claim 6,
in which the profiled body is fed into the printing area and positioned in cycle mode, and
in which the at least one print head is moved and controlled for a printing operation for printing the profiled body.

8. The method according to claim 6,
in which the profiled body is fed between two printing processes and a new section of the profiled body is positioned.

9. The method according to claim 6,
in which the at least one print head is moved back and forth between the end positions for a printing operation or is moved from one end position to the other end position.

10. The method according to claim 6,
in which the printing ink is cured during the printing process in the printing direction behind the imprint, in particular by means of UV light.

11. The method according to claim 6,
in which the profiled body is deionized in the printing direction before printing.

12. The method according to claim 6,
in which the profiled body is temporarily stored by means of an input-side dancer arrangement and/or with an output-side dancer arrangement.
